(19) United States
(12) Patent Application Publication
(10) Pub. No.: US 2007/0294133 A1
(43) Pub. Date: Dec. 20, 2007

(54) System and method for connecting and managing data transfers over the internet

(75) Inventors: Zephrin I. Lasker, Brooklyn, NY (US); Roshan B. Bangera, Brooklyn, NY (US); Geoffrey B. Grauer, Seattle, WA (US); Nicholas P. Herman, Brooklyn, NY (US)

Correspondence Address: Michael B. Einschlag;Rosenlaw & Einschlag, 25680 Fernhill Drive, Los Altos Hills, CA, 94024, US

(73) Assignee: Pontiflex LLC, Brooklyn, NY (US)

(21) Appl. No.: 11/801,330

(22) Filed: May 9, 2007

Related U.S. Application Data
(60) Provisional application No. 60/799,140, filed on May 10, 2006.

(51) Int. Cl. G07G 1/14

(52) U.S. Cl. 705/14

(57) ABSTRACT

One embodiment of the present invention is a data bridge between publishers and advertisers for sending data from a publisher to an advertiser, which data bridge comprises: a computer system, which computer system includes: (a) an advertiser configurator; (b) a publisher configurator; (c) a configuration data store; (d) a data transfer configurator; (e) a data transfer scheduler; (f) a data transfer engine; (g) a primary data store; (h) a tracking and billing component; and (i) an archiver.

This patent application relates to U.S. Provisional Application No. 60/799,140 filed May 10, 2006, from which priority is claimed under 35 USC §119(e), and which provisional application is incorporated herein in its entirety.

### TECHNICAL FIELD OF THE INVENTION

One or more embodiments of the present invention relate to system and method for connecting and managing data transfers over the Internet.

### BACKGROUND OF THE INVENTION

The Internet has become an important new medium for advertising. In general, buyers and sellers of Internet advertising can be divided into two of the following categories: (a) publishers (a publisher is also referred to herein as a “data source”)—for example and without limitation, a publisher is a website or a network of websites or a mobile phone network or a television network that displays advertising units on behalf of advertisers (examples of publishers are Aptimus, Valueclick, Verizon Wireless, Comcast Cable, New York Times Online, and Lycos); and (b) advertisers (an advertiser is also referred to herein as a “data consumer”)—for example and without limitation, an advertiser is a company (selling a product or service) that contracts with a publisher to display the advertiser's ads or advertising units on the publisher's sites (examples of advertisers are HPShopping, Verisign, Circuit City and eFax).

As is well known, common types of online advertising units are, for example and without limitation, banners, buttons, opt-ins, email and paid search. In general, publishers display advertising units for advertisers and collect data from users who respond to the advertising units. Then, publishers need to send the collected data to the advertisers. Online advertising units can be divided into two of the following categories based on a method by which advertisers collect data from the user: (a) redirected ad units wherein users click on a banner advertisement, search result, or other advertising unit and are thereby redirected (for example and without limitation, either in a new browser window or by refreshing a current browser window) to an advertiser's web form—users then manually complete the web form by entering the required data; and (b) publisher-collected ad units wherein users take some action (for example and without limitation, checking, or leaving checked, a pre-selected check-box—often during a website registration process) that causes the publisher to transfer the user's data in the background to the advertiser.

Two major growth limitations currently undermine the publisher-collected advertising market today: (a) a lack of easy connectivity; and (b) a need for manual integration. In the publisher-collected advertising market or market segment (for example and without limitation, co-registration and lead generation are two common markets), there is no easy way to transfer data from publishers to advertisers. No data delivery standards exist. Each new deal, and new partner, requires a new customized data transfer solution to be set up by the deal parties. Data is delivered via ad-hoc HTTP POST routines, email, or FTP. The iterative nature of current solutions causes delays, poor allocation of resources and leads to lost business opportunities.

Typically, Data Sources (for example, publishers of online advertising that sell advertising placement on their website or network of websites) and Data Consumers (for example, buyers of online advertising who buy these advertising placements to promote their products) belong to different organizations. Even though open data transfer protocols such as FTP, RCP, SFTP, SCP, HTTP, HTTPS, and SOAP exist for use in transferring data, currently, Data Sources have to build multiple point-to-point connections to their Data Consumers to send data. Similarly, Data Consumers have to build multiple point-to-point connections to their Data Sources to receive data. Each of these separate connections between Data Sources and Data Consumers is typically accomplished using a different data transfer protocol, depending on the capabilities and requirements of the Data Source and Data Consumer. In some cases the data transfer is impossible if the Data Source and Data Consumer cannot find a common data transfer protocol. Thus, a problem exists in that Data Sources and Data Consumers spend much effort in setting up new data transfers and managing existing data transfers.

In light of the above, there is a need in the art for systems and methods that solve one or more of the above-identified problems.

### SUMMARY OF THE INVENTION

One or more embodiments of the present invention comprise a computer system that provides a data bridge connecting publishers (a publisher is also referred to herein as a “data source”), for example and without limitation, online publishers, to advertisers (an advertiser is also referred to herein as a “data consumer”), for example and without limitation, online advertisers, to transfer data between them. In particular, one or more embodiments of the present invention comprise a computer system that mediates data transfers so that data sources can connect to the computer system in their preferred data transfer protocol to send data, and data consumers can build their connections to the computer system in their preferred data transfer protocol to receive data. As such, in accordance with one or more embodiments of the present invention, by converting data received from data sources into data sent to data consumers, the computer system provides a flexible data bridge that enables simple connectivity between parties, immediate delivery of customer data, lowered cost of doing business, and imparts greater value for data being transferred.

As will be described below, in accordance with one or more embodiments of the present invention, the computer system integrates online data transfers (typically comprised of data provided by customers such as, for example and without limitation, name, email address, zip code, credit card number, or other information) between publishers and advertisers using a set up process. Once the set up process is complete, in accordance with one or more embodiments of the present invention, the computer system translates data received from a publisher (i.e., a data source) and sends data to an advertiser (i.e., a data consumer) by automatically recognizing the data output format provided by the publisher and converting that information into the data input format required by the advertiser. In addition, in accordance with one or more embodiments of the present invention, the computer system can archive the data for backup purposes, and all transfer statistics and metrics can be viewed by users via a web interface.

In accordance with one or more embodiments of the present invention, as will be described below, the computer system and its described method of operation enable (and advantageously simplify) data transfer between data sources and data consumers via, for example and without limitation, open data transfer protocols. In accordance with one or more such embodiments, the data transferred may be in the form of a data structure, for example and without limitation, a data structure in tabular form consisting of one or more rows, with each row consisting of one or more columns (fields).

As will be described below, in accordance with one or more embodiments of the present invention, the computer system will automatically guess and map each advertiser data field to a publisher data field using string matching algorithms to compare and match data field names. Advantageously, this enables publishers and advertisers to skip an intermediate step of manually matching and connecting advertiser and publisher list of fields, and reduces the number of steps to set up a data transfer in the computer system.

In accordance with one or embodiments of the present invention, as described below, the computer system and its described method of operation provide the following capabilities: (a) a web-enabled interface (for example and without limitation, a form) for use by users to sign up for services rendered by the computer system; (b) a web-enabled interface (for example and without limitation, a form) to set up data source configurations that specify (i) data transfer protocols used to transfer data from a data source to the computer system, and (ii) data fields that make up each record of data received from the data source; (c) a web-enabled interface (for example and without limitation, a form) to set up data consumer configurations that specify (i) data transfer protocols used to transfer data from the computer system to a data consumer, and (ii) data transfer fields that make up each record of data to be sent to the data consumer; and (d) a web-enabled interface (for example and without limitation, a form) to set up data transfer configurations that specify (i) whether the computer system will pull data from a data source or the data source will push data to the computer system, (ii) where the data source will push data to the computer system, the computer system will create a data storage area for the data transfer, and, if required by the data transfer protocol (specified in the data source configuration), will generate credentials to access the data storage area, (iii) where the computer system will pull data from the data source, the data store information and credentials required by the computer system to access a data store created by the data source, (iv) whether the computer system will push data to a data consumer or the data consumer will pull the data from computer system, (v) where the data consumer will pull data from the computer system, the computer system will create a data storage area for the data transfer, and if required by the data transfer protocol (as specified in data consumer configuration), generate credentials to access the data storage area, (vi) where the computer system will push data to the data consumer, the data store information and credentials required by the computer system to access the data storage area created by the data consumer, and (vii) the computer system will automatically match the list data fields to be sent to the data consumer to the list of data fields received from the data source and will provide a web-based form to have the user verify and manually correct any mismatches between the two sets of data fields.

In particular, one embodiment of the present invention is a data bridge between publishers and advertisers for sending data from a publisher to an advertiser, which data bridge comprises: a computer system, which computer system includes: (a) a data consumer configurator; (b) a data source configurator; (c) a configuration data store; (d) a data transfer configurator; (e) a data transfer scheduler; (f) a data transfer engine; (g) a primary data store; (h) a tracking and billing component; and (i) an archiver.

### BRIEF DESCRIPTION OF THE DRAWING

FIG. 1 is a block diagram of a system architecture of a computer system that is fabricated in accordance with one or more embodiments of the present invention;

FIGS. 2-4 are computer screens that are used in describing a data consumer configurator that is fabricated in accordance with one or more embodiments of the present invention;

FIGS. 5-7 are screens that are used in describing a data source configurator that is fabricated in accordance with one or more embodiments of the present invention;

FIGS. 8-11 are screens that are used in describing a data transfer configurator that is fabricated in accordance with one or more embodiments of the present invention;

FIG. 12 is a flow chart that is used in describing a typical data transfer setup process using the data transfer configurator that is fabricated in accordance with one or more embodiments of the present invention;

FIGS. 13-15 are diagrams that are used in describing data components that make up a data source configuration, a data consumer configuration and a data transfer configuration, respectively, as stored in the configuration data store;

FIG. 16 is a flow chart that is used in describing a process for a data transfer engine to transfer data from a data source to a data consumer, which process is fabricated in accordance with one or more embodiments of the present invention;

FIG. 17 shows an HTML source code view of a sample data source-owned HTML web page that includes a BrowserScriptPost code snippet that is fabricated in accordance with one or more embodiments of the present invention; and

FIG. 18 shows pseudo code describing a JavaScript function of a component of the BrowserScriptPost code snippet shown in FIG. 17.

### DETAILED DESCRIPTION

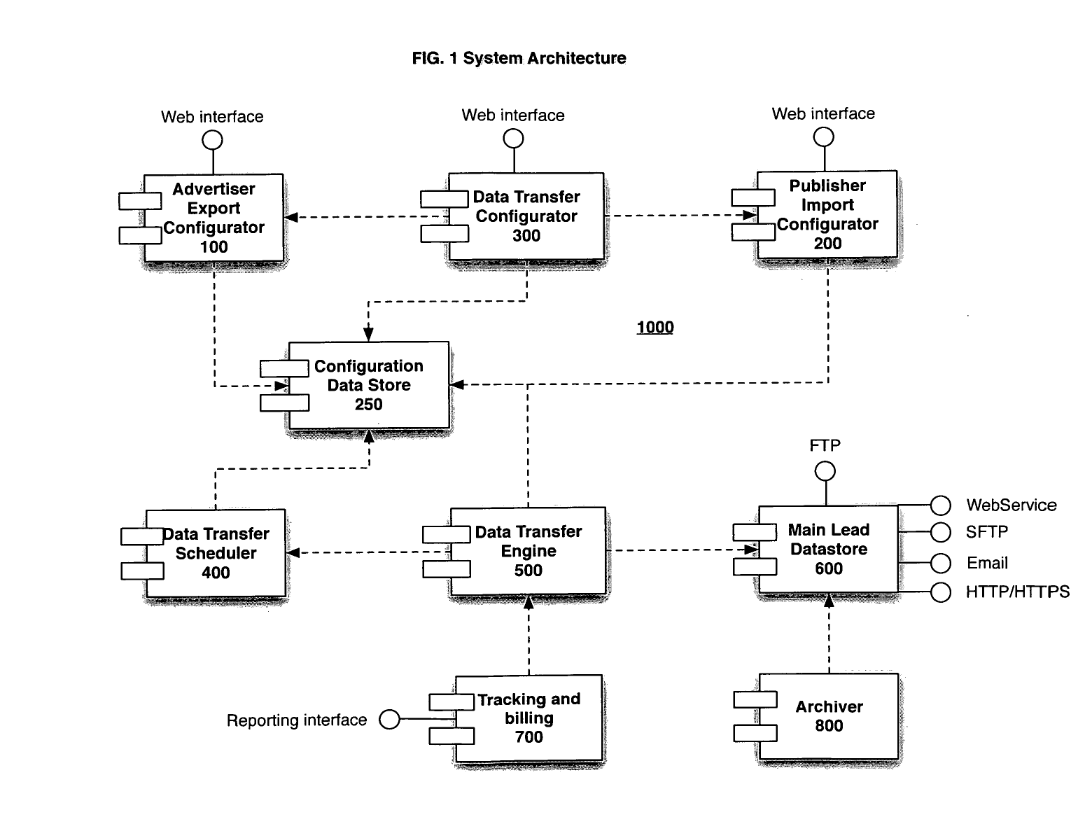

FIG. 1 is a block diagram of a system architecture of computer system 1000 that is fabricated in accordance with one or more embodiments of the present invention. As shown in FIG. 1, computer system 1000 comprises data consumer (or advertiser export) configurator 100, data source (or publisher import) configurator 200, configuration data store 250, data transfer configurator 300, data transfer scheduler 400, data transfer engine 500, primary (or main lead) data store 600, tracking and billing component 700, and archiver 800. As one of ordinary skill in the art can readily appreciate, data consumer configurator 100, data source configurator 200, configuration data store 250, data transfer configurator 300, data transfer scheduler 400, data transfer engine 500, primary data store 600, tracking and billing component 700, and archiver 800 are combinations of software modules and computer hardware that provide functionality that will be described in detail below.

Certain parts of the description below refer to a data source and a data consumer having web access to computer system 1000. In accordance with one or more embodiments of the present invention, this is done by a data source and a data consumer first going to a website of a company (for example, Pontiflex) running computer system 1000 and registering for an account. Registration may be done, for example and without limitation, by providing registration credentials such as, for example and without limitation, a name, email address, mailing address, and perhaps other contact information. The registration credentials are reviewed by the company (for example, Pontiflex) staff, and, provided they are judged to be valid in accordance with company criteria, the company staff creates an account for the user and sends login credentials (for example, user ID and password) to the user via email or telephone. Users then can go to the company's website and click a “Log In” button and use these credentials to log in to computer system 1000. In accordance with one or more further embodiments, users can create their own accounts without prior approval by company staff. In accordance with one or more such embodiments, upon submitting their credentials, computer system 1000 automatically creates and presents a password and usemame for the registrant after they register. However, in either case, company staff have an option to disable a user account of user immediately via computer system 1000.

Data Consumer Section

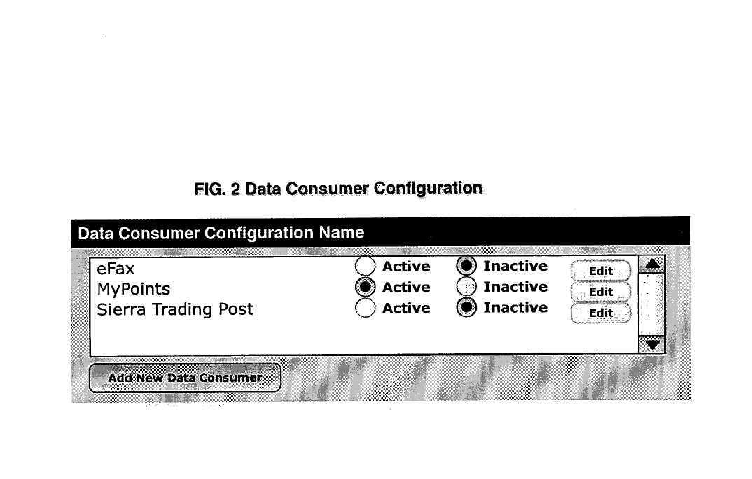

FIGS. 2-4 are screens used in describing data consumer configurator 100 that is fabricated in accordance with one or more embodiments of the present invention to help one of ordinary skill in the art understand how to make and use computer system 1000. In accordance with one or more embodiments of the present invention, data consumer configurator 100 is a module of computer system 1000 that exposes an interface, for example and without limitation, a web interface, in accordance with any one of a number of methods that are well known to those of ordinary skill in the art, wherein a data consumer can specify parameters required to receive data from computer system 1000. In accordance with one or more embodiments of the present invention, the data consumer uses the interface as a set up tool, for example and without limitation, as a one-time set up tool, to specify configuration data (also referred to herein as a “configuration”) relating, among other things, to how computer system 1000 will send data to the data consumer. In accordance with one or more embodiments of the present invention, the data consumer will need to change its configuration data only if it makes changes, for example and without limitation, in the way it wants or needs to receive data from computer system 1000. In addition, in accordance with one or more embodiments of the present invention, a data consumer, if it chooses, can specify multiple configurations, for example and without limitation, one configuration for each different method of receiving data from computer system 1000. As will be described in detail below, the interface will provide web pages: (a) listing all existing configurations; (b) listing options to edit existing configurations; and (c) enabling addition of new configurations.

For a data consumer to initiate a new data consumer configuration or to edit an existing one, the data consumer accesses a web interface exposed by data consumer configurator 100 by clicking on a link to the web interface in a browser. In response, data consumer configurator 100 queries configuration data store 250 to retrieve all existing data consumer configurations set up by the data consumer previously (in accordance with any one of a number of methods that are well known to those of ordinary skill in the art), and data consumer configurator 100 displays this data as a list in the screen shown in FIG. 2 (in accordance with any one of a number of methods that are well known to those of ordinary skill in the art). As shown in the screen shown in FIG. 2, and in accordance with one or more embodiments of the present invention, each data consumer configuration has a name, and a flag (“Active” or “Inactive”) used to indicate to data transfer engine 500 that the data consumer will accept data according to the format and method specified by this data consumer configuration. In addition, as shown in the screen shown in FIG. 2, an “Edit” button is displayed next to each data consumer configuration (in accordance with any one of a number of methods that are well known to those of ordinary skill in the art) to allow the data consumer to edit the data consumer configuration. In addition, an “Add New Data Consumer” button is displayed to enable the data consumer to create a new data consumer configuration.

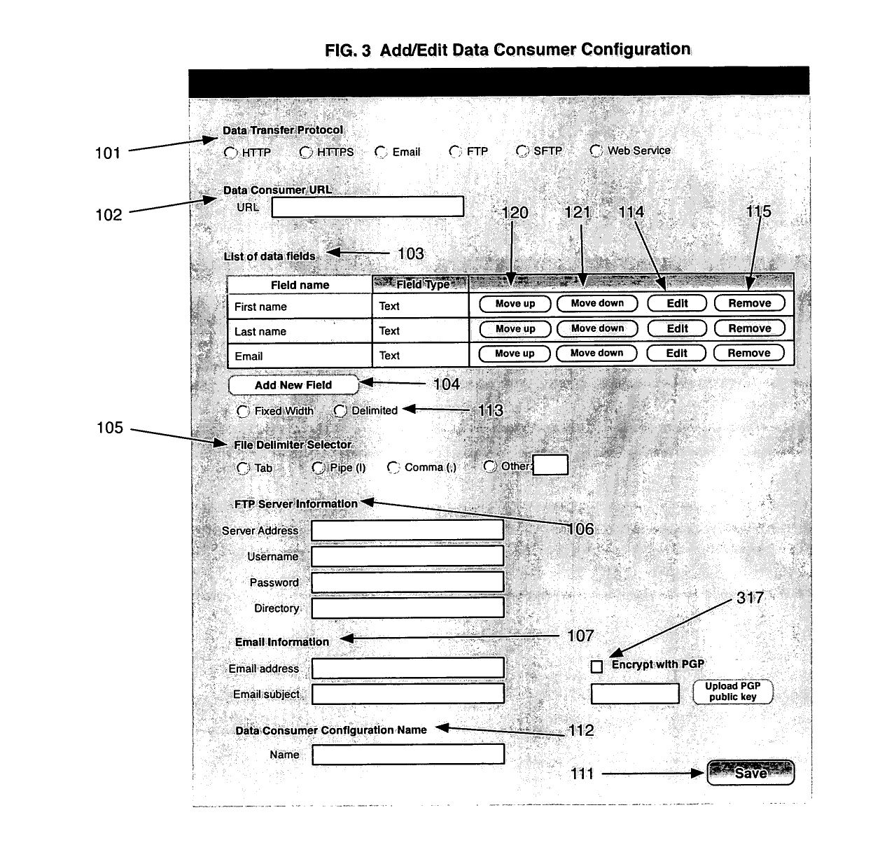

In response to the data consumer's clicking the “Edit” button on the screen shown in FIG. 2, in accordance with one or more embodiments of the present invention, data consumer configurator 100 presents the screen shown in FIG. 3, pre-populated with the selected data consumer configuration information (in accordance with any one of a number of methods that are well known to those of ordinary skill in the art). In response to the data consumer's clicking the “Add New Data Consumer” button on the screen shown in FIG. 2, in accordance with one or more embodiments of the present invention, data consumer configurator 100 presents the screen shown in FIG. 3 (in accordance with any one of a number of methods that are well known to those of ordinary skill in the art). FIG. 3 illustrates an instance of a data consumer configuration with Data Transfer Protocol selector 101, Data Consumer URL form 102, List of data fields 103, “Add New Field” button 104, File Delimiter Selector 105, optional FTP Server Information form 106, optional Email Information form 107, and Data Consumer Configuration Name 112. Based on user selection from Data Transfer Protocol selector 101, data consumer configurator 100 will conditionally display Data Consumer URL form 102, File Delimiter Selector 105, FTP Server Information form 106, or Email Information form 107. For example, if the user selects HTTP or HTTPS from Data Transfer Protocol selector 101, Data Consumer URL form 102 is displayed and File Delimiter Selector 105, FTP Server Information form 106, and Email Information form 107 are not displayed. However, if the user selects FTP or SFTP from Data Transfer selector 101, then File Delimiter Selector 105 and FTP Server Information form 106 are displayed, and Data Consumer URL form 102 and Email Information form 107 are not displayed. Lastly, if the user selects Email from Data Transfer Selector 101, then File Delimiter Selector 105 and Email Information form 107 are displayed, and Data Consumer URL form 102 and FTP Server Information form 106 are not displayed.

Data Transfer Protocol selector 101 specifies the data transfer protocol that must be used for the data consumer to accept data from computer system 1000. In accordance with one or more embodiments of the present invention, data consumer configurator 100 displays a list of data transfer protocols (for example and without limitation, FTP, RCP, SFTP, SCP, HTTP, HTTPS, and SOAP via Web Service) from which the data consumer may choose. Data Consumer URL form 102 is the data consumer's web URL which computer system 1000 will use to transfer data to the data consumer if the data consumer selects to transfer data using HTTP or HTTPS POST. List of data fields 103 specifies the data fields that make up a single data record of the data transfer to the data consumer. In accordance with one or more embodiments of the present invention, on the screen shown in FIG. 3, the data consumer will specify: (a) in case the user selects FTP or Email for data transfer protocol, the required ordering of data fields (as shown in the screen shown in FIG. 3) within each row of data (in accordance with one or more embodiments of the present invention, the data consumer specifies the ordering of data fields by clicking on “Move up” button 120 or “Move down” button 121); (b) data fields to be removed from list of data fields 103 by clicking on “Remove” button 115; and (c) whether to have data fields in fixed-width format or to have data fields be delimited by a chosen character using selector 113. If the data consumer chooses to use delimited data fields by selecting a “Delimited” option for selector 113 on the screen shown in FIG. 3, the data consumer will specify a delimiter character using File Delimiter Selector 105. File Delimiter Selector 105 specifies the delimiter character that will be used to separate the data fields. File Delimiter Selector 105 will be shown only if the data consumer elects to transfer data using FTP or SFTP or email data transfer protocols. The delimiter character can be, for example and without limitation, comma(,), tab(\t), pipe(|), or any other single character of the data consumer's choice (in accordance with any one of a number of methods that are well known to those of ordinary skill in the art).

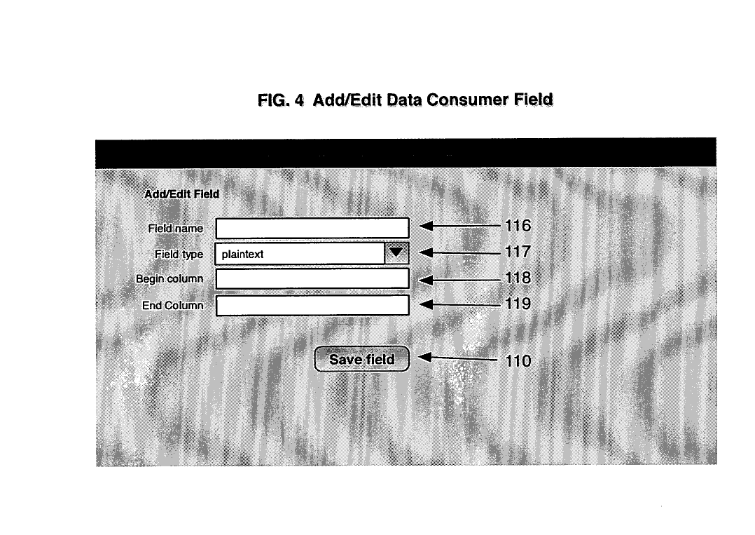

FTP Server Information form 106 includes the FTP server address, FTP server username and password, and FTP directory name that will be used by computer system 1000 to transfer data to the data consumer if the data consumer elects to transfer data using FTP or SFTP. Email Information form 107 includes the email addresses and email subject that will be used by computer system 1000 to transfer data to the data consumer if the data consumer elects to transfer data using Email. If the user clicks on “Add New Field” button 104, data consumer configurator 100 will display the screen shown in FIG. 4.

To use the screen shown in FIG. 4, the user will enter a field name in Field name 116, and select a field type using Field type 117. If the user chooses to use a fixed width format by selecting a “Fixed width” option from selector 113 on the screen shown in FIG. 3, data consumer configurator 100 will present a begin column number in Begin column 118 and an end column number in End column 119 for the new field on the screen shown in FIG. 4. The user selects a field type from an existing list of field types in Field type 117 to identify the format of the data field to computer system 1000, examples of field types include text, number, date, phone number, country code, state, zip. After the user clicks “Save field” button 1 10 on the screen shown in FIG. 4, the data consumer configurator 100 adds the field name to the data consumer configuration, and the new field is displayed on list of fields 103 on the screen shown in FIG. 3. If the user clicks on “Edit” button 114 on the screen shown in FIG. 3, data consumer configurator 100 displays the screen shown in FIG. 4 pre-populated with the selected field name in Field name 116, and a field type in Field type 117. In addition, if the user selects the “Fixed Width” option from selector 113 on the screen shown in FIG. 3, data consumer configurator 100 displays a begin column number in Begin column 118 and an end column number in End column 119 on the screen shown in FIG. 4. After the user clicks on “Save Field” button 110 on the screen shown in FIG. 4, the data consumer configurator 100 stores the changes to the field, and the changes are reflected in List of data fields 103 on the screen shown in FIG. 3. In accordance with one or more embodiments of the present invention, the data consumer can choose to receive files securely by having computer system 1000 send files encrypted using the data consumer's PGP key. To do this, the data consumer will select “Encrypt with PGP” checkbox 317 on the screen shown in FIG. 3, and enter an address of a file containing the PGP public key or browse its own system (in accordance with any one of a number of methods that are well known to those of ordinary skill in the art) to find the PGP public key file. In response, data consumer configurator 100 will upload the data consumer's PGP public key, and store it in configuration data store 250. Later, computer system 1000 will use the data consumer's PGP public key to encrypt files to be transferred to the data consumer.

The user enters a human-readable name in Data Consumer Configuration Name form 112 to identify the data consumer configuration in data consumer configurator 100. After entering the required information on the screen shown in FIG. 3, the user clicks on “Save” button 111 to save the data consumer configuration to configuration data store 250.

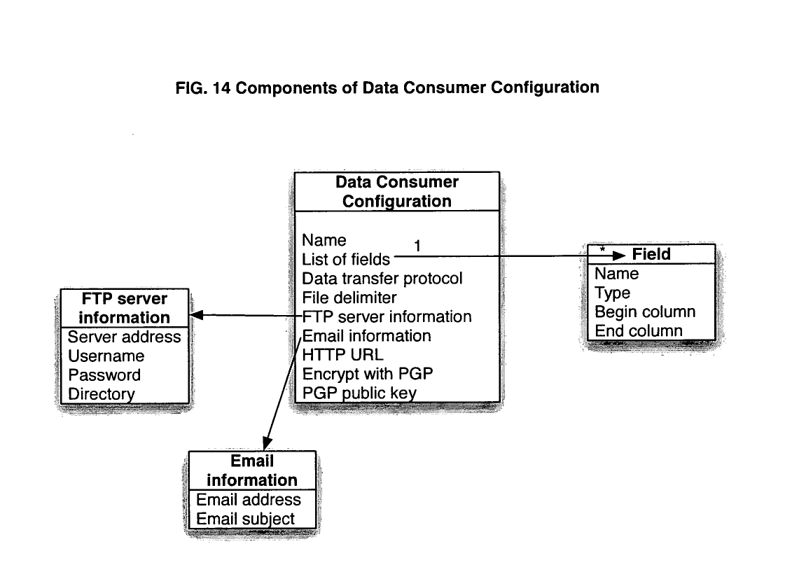

In accordance with one or more embodiments of the present invention, data consumer configurator 100 stores the data consumer configuration in machine-readable format (for example and without limitation, in XML or as normalized database tables) in configuration data store 250 (in accordance with any one of a number of methods that are well known to those of ordinary skill in the art). The data components comprising the data consumer configuration are set forth in detail in FIG. 14.

Data Source Section

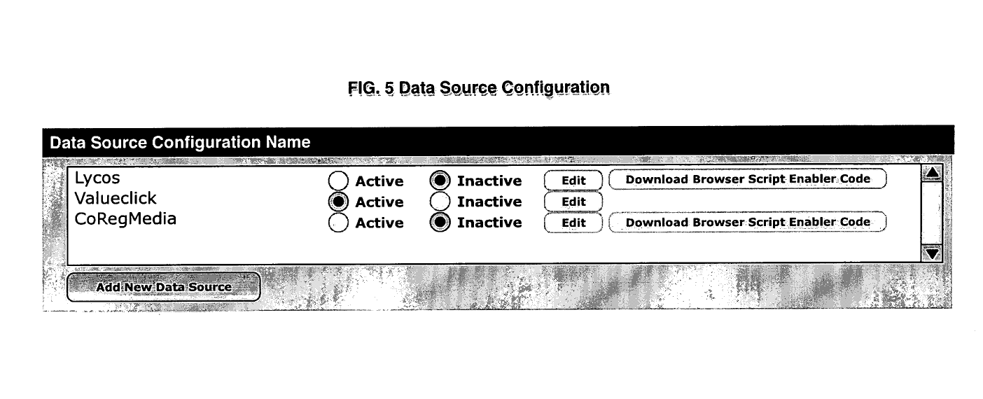

For a data source to initiate a new data source configuration or to edit an existing one, the data source accesses a web interface exposed by data source configurator 200 by clicking on a link to the web interface in a browser. In response, data source configurator 200 queries configuration data store 250 to retrieve all existing data source configurations set up by the data source previously (in accordance with any one of a number of methods that are well known to those of ordinary skill in the art), and data source configurator 200 displays this data as a list in the screen shown in FIG. 5 (in accordance with any one of a number of methods that are well known to those of ordinary skill in the art). As shown in the screen shown in FIG. 5, and in accordance with one or more embodiments of the present invention, each data source configuration has a name, and a flag (“Active” or “Inactive”) used to indicate to data transfer engine 500 that the data source will send data according to the format and method specified by this data source configuration. In addition, as shown in the screen shown in FIG. 5, an “Edit” button is displayed next to each data source configuration (in accordance with any one of a number of methods that are well known to those of ordinary skill in the art) to allow the data source to edit the data source configuration. In addition, an “Add New Data Source” button is displayed to enable the data source to create a new data source configuration.

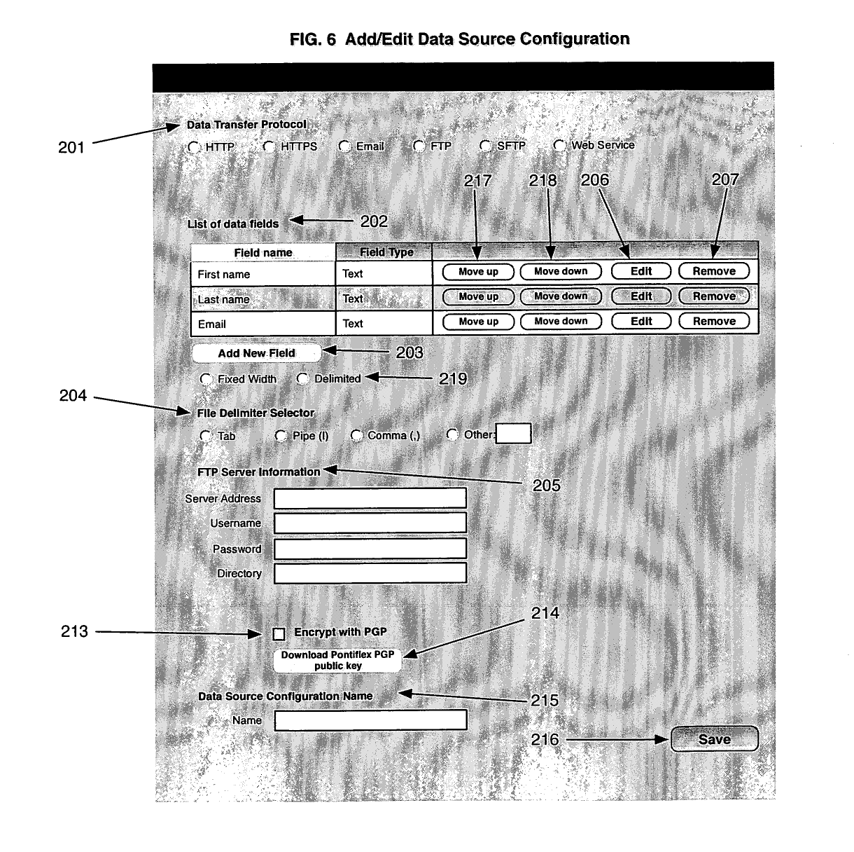

In response to the data source's clicking the “Edit” button on the screen shown in FIG. 5, in accordance with one or more embodiments of the present invention, data source configurator 200 presents the screen shown in FIG. 6, pre-populated with the selected data source configuration information (in accordance with any one of a number of methods that are well known to those of ordinary skill in the art). In response to the data source's clicking the “Add New Data Source” button on screen shown in FIG. 5, in accordance with one or more embodiments of the present invention, data source configurator 200 presents the screen shown in FIG. 6 (in accordance with any one of a number of methods that are well known to those of ordinary skill in the art). FIG. 6 illustrates an instance of a data source configuration with Data Transfer Protocol selector 201, List of data fields 202, “Add New Field” selector 203, File Delimiter Selector 204, optional FTP Server Information form 205, and Data Source Configuration Name form 206. Based on user selection from Data Transfer Protocol selector 201, data source configurator 200 will conditionally display File Delimiter Selector 204 or FTP Server Information form 205. For example, if the user selects HTTP or HTTPS from Data Transfer Protocol selector 201, File Delimiter Selector 204 and FTP Server Information form 205 are not displayed. However, if the user selects FTP or SFTP from Data Transfer Protocol Selector 201, then File Delimiter Selector 204 and FTP Server Information form 205 are displayed.

Data Transfer Protocol selector 201 specifies the data transfer protocol that the data source will use to send data to computer system 1000. In accordance with one or more embodiments of the present invention, data source configurator 200 displays a list of data transfer protocols (for example and without limitation, FTP, RCP, SFTP, SCP, HTTP, HTTPS, and SOAP via Web Service) from which the data source may choose. List of data fields 203 specifies the data fields that make up a single data record of the data transfer from the data source. In accordance with one or more embodiments of the present invention, on the screen shown in FIG. 6, the data source will specify: (a) in case the user selects FTP or Email for data transfer protocol, the required ordering of data fields (as shown in the screen shown in FIG. 6) within each row of data (in accordance with one or more embodiments of the present invention, the data source specifies the ordering of data fields by clicking on “Move up” button 217 or “Move down” button 218); (b) data fields to be removed from List of data fields 202 by clicking on “Remove” button 207; and (c) whether to have data fields in fixed-width format or to have data fields be delimited by a chosen character using selector 219. If the data source chooses to use delimited data fields by selecting a “Delimited” option for selector 219 on the screen shown in FIG. 6, the data source will specify a delimiter character using File Delimiter Selector 204. File Delimiter Selector 204 specifies the delimiter character that will be used to separate the data fields. File Delimiter Selector 204 will be shown only if the data source elects to transfer data using FTP or SFTP or email data transfer protocols. The delimiter character can be, for example and without limitation, comma(,), tab(\t), pipe(|), or any other single character of its choice (in accordance with any one of a number of methods that are well known to those of ordinary skill in the art).

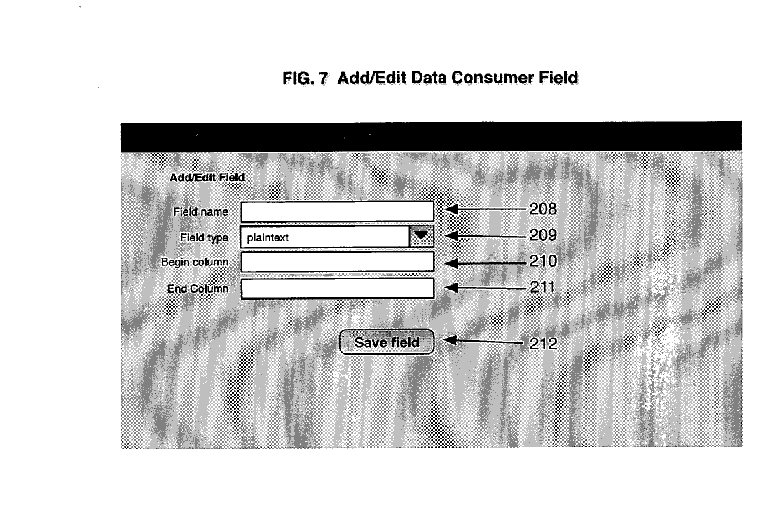

FTP Server Information form 205 includes the FTP server address, the FTP server username and password, and the FTP directory name that will be used by computer system 1000 to receive data from the data source if the data source elects to transfer data using FTP or SFTP. If the user clicks on “Add New Field” button 203, data source configurator 200 displays the screen shown in FIG. 7.

To use the screen shown in FIG. 7, the user will enter the field name Field name 208, and select a field type using Field type 209. If the user chooses to use a fixed width format by selecting a “Fixed width” option from selector 219 on the screen shown in FIG. 6, data source configurator 200 will present a begin column number in Begin column 210 and an end column number in End column 211 for the new field on the screen shown in FIG. 7. After the user clicks “Save field” button 212 on the screen shown in FIG. 7, data source configurator 200 adds the field name to the data source configuration, and the new field is displayed on List of data fields 202. If the user clicks on “Edit” button 206 on the screen shown in FIG. 6, data source configurator 200 displays the screen shown in FIG. 7 pre-populated with the selected field name in Field name 208 and a field type in Field type 209. In addition, if the user selects the “Fixed Width” option from selector 219 on the screen shown in FIG. 6, data source configurator 200 displays a begin column number in Begin column 210 and an end column number in End column 211 on the screen shown in FIG. 7. After the user clicks on “Save field” button 212 on the screen shown in FIG. 7, data source configurator 200 stores the changes to the field, and the changes are reflected in List of data fields 202 on the screen shown in FIG. 6. In accordance with one or more embodiments of the present invention, the data source can choose to send files securely by encrypting files with computer system 1000's public PGP key. To do this, the data source will click “Encrypt with PGP” checkbox 213 on the screen shown in FIG. 6, and click on “Download Pontiflex PGP public key” button 214. In response, the data source will download computer system 1000's public PGP key. In accordance with one or more embodiments of the present invention, computer system 1000 will decrypt files sent by the data source using computer system 1000's PGP private key.

The user enters a human-readable name in Data Source Configuration Name form 215 to identify the data source configuration in data source configurator 200. After entering the required information on the screen shown in FIG. 6, the user clicks on “Save” button 216 to save the data source configuration to configuration data store 250.

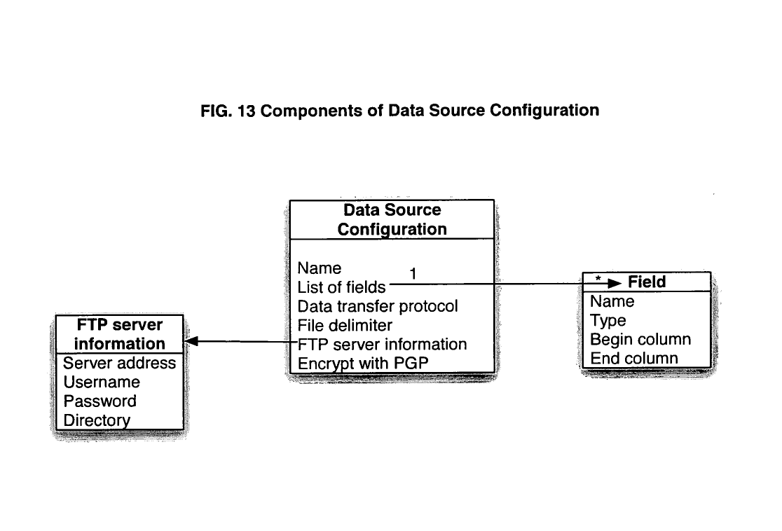

In accordance with one or more embodiments of the present invention, data source configurator 200 stores the data source configuration in machine-readable format (for example and without limitation, in XML or as normalized database tables) in configuration data store 250 (in accordance with any one of a number of methods that are well known to those of ordinary skill in the art). The data components comprising the data source configuration are set forth in detail in FIG. 13.

Data Transfer Section

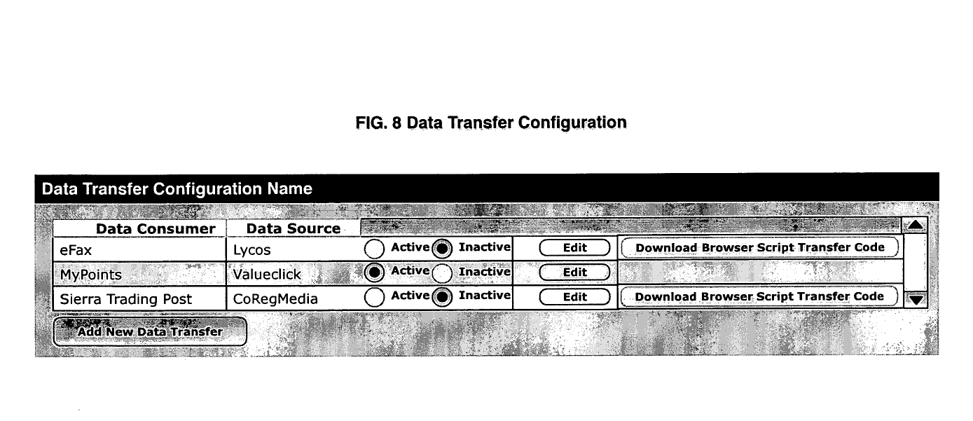

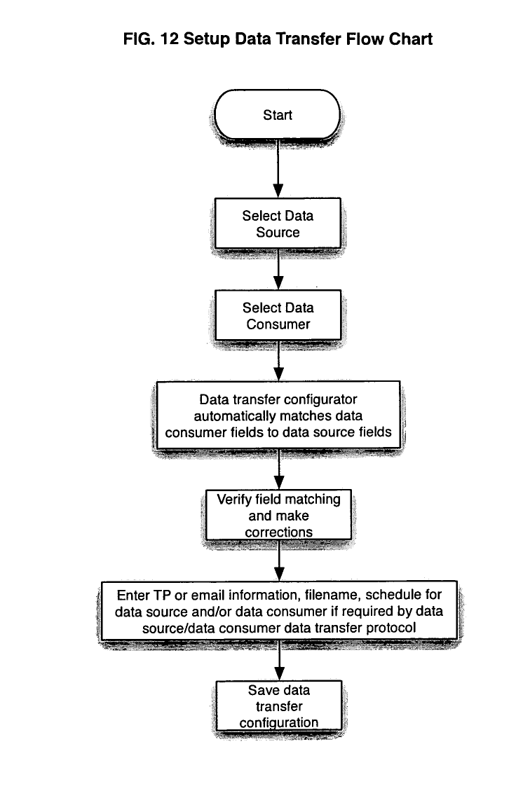

FIG. 12 is a flow chart that summarizes the process used to set up a data transfer configuration using a data transfer configurator that is fabricated in accordance with one or more embodiments of the present invention. In accordance with one or more embodiments of the present invention, data transfer configurator 300 is a module of computer system 1000 that exposes an interface, for example and without limitation, a web interface, wherein a user can set up a data transfer from a data source to a data consumer using a pre-existing data source configuration and data consumer configuration from configuration data store 250. In accordance with one or more embodiments of the present invention, users will use this interface as a set up (for example, one-time set up) tool for each data transfer. A data transfer configuration will need to change only if the data source or the data consumer changes its respective configuration. In accordance with one or more embodiments of the present invention, the interface shown on screen in FIG. 8 will display web pages where a user can view its current data transfer configurations, edit these data transfer configurations, and/or add new data transfer configurations.

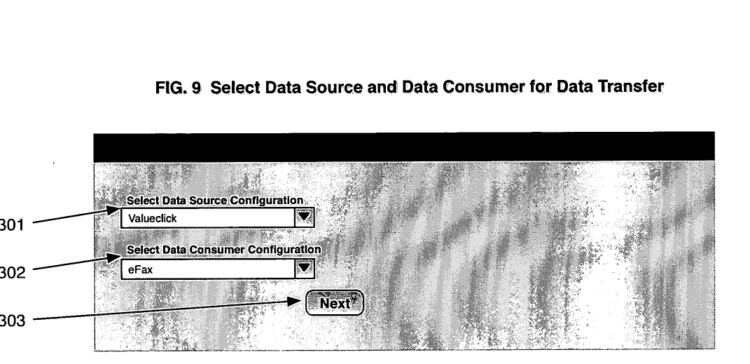

For a user to initiate a new data transfer configuration or to edit an existing one, the user accesses a web interface exposed by data transfer configurator 300 by clicking on a link to the web interface in a browser. In accordance with one or more embodiments of the present invention, upon a user's initiating a new data transfer configuration, or editing an existing data transfer configuration, data transfer configurator 300 will present web forms requesting information. In accordance with one or more embodiments of the present invention, first, data transfer configurator 300 displays the screen shown in FIG. 9. The user selects a data source configuration from “Select Data Source Configuration” list 301 and selects a data consumer configuration from “Select Data Consumer Configuration” list 302. Data transfer configurator 300 creates “Select Data Source Configuration” list 301 by listing all data source configurations in configuration data store 250 (in accordance with any one of a number of methods that are well known to those of ordinary skill the art). Data transfer configurator 300 creates “Select Data Consumer Configuration” list 302 by listing all data consumer configurations in configuration data store 250 (in accordance with any one of a number of methods that are well known to those of ordinary skill the art). After selecting a data source configuration and a data consumer configuration, the user clicks on “Next” button 303 on the screen shown in FIG. 9.

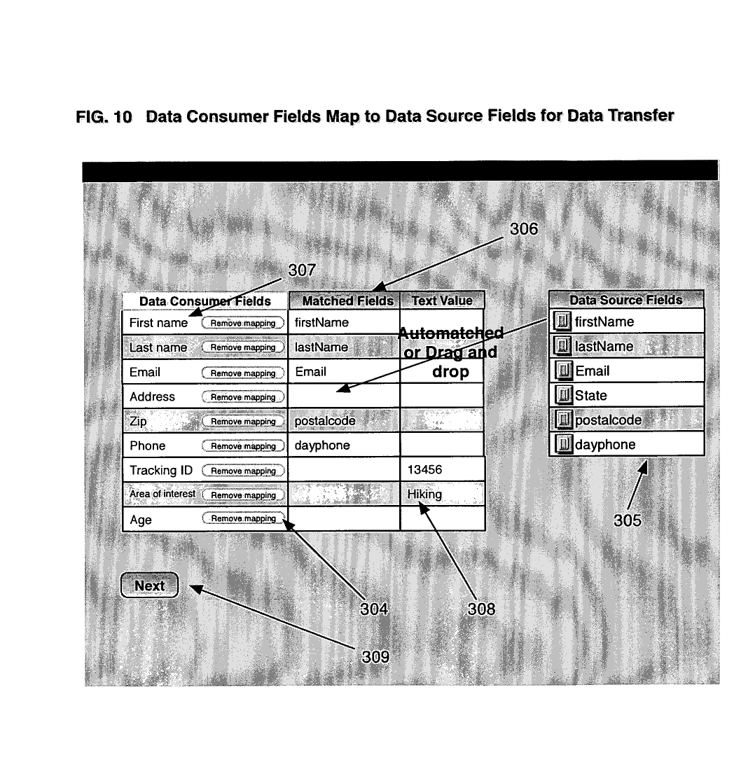

In accordance with one or more embodiments of the present invention, whenever the user clicks on “Next” button 303 on the screen shown in FIG. 9, data transfer configurator 300 will map each data field defined in the data consumer configuration selected on the screen shown in FIG. 9 to data fields defined in the data source configuration selected in the screen shown in FIG. 9. Data transfer configurator 300 maps a data consumer field to a data source field by selecting the data source field name which best matches the data consumer field name using, for example and without limitation, established and existing implementations of approximate string matching algorithms (in accordance with any one of a number of methods that are well known to those of ordinary skill the art such as, for example and without limitation, those referenced at http://en.wikipedia.org/wiki/Approximate string matching and http://en.wikipedia.org/wiki/agrep, nrgrep, cgrep. After mapping data consumer fields to data source fields, the data transfer configurator 300 displays the screen shown in FIG. 10 where the user can verify these mappings and modify them if required.

In accordance with one or more embodiments of the present invention, the user can modify these mappings by either clicking on “Remove mapping” button 304 on the screen shown in FIG. 10, or by dragging and dropping a data source field from “Data Source Fields” list 305 on the screen shown in FIG. 10 to a desired mapping drop Matched Fields area 306 on the screen shown in FIG. 10 corresponding to the data consumer field in “Data Consumer Fields” list 307. However, instead of mapping a data source field to a data consumer field, in accordance with one or more such embodiments of the present invention, the user can instead map a text value to a data consumer field by entering the text value in “Text Value” field 308 on the screen shown in FIG. 10.

In accordance with one or more embodiments of the present invention, data transfer engine 500 uses mappings defined on the screen shown in FIG. 10 to map data sent by the data source to data sent to the data consumer. In particular, it does this by using a value in the data source field and populating that value in a corresponding data consumer field. In the case where the data consumer field is mapped to a fixed text value instead of a data source field, the fixed text value is used to populate the data consumer field.

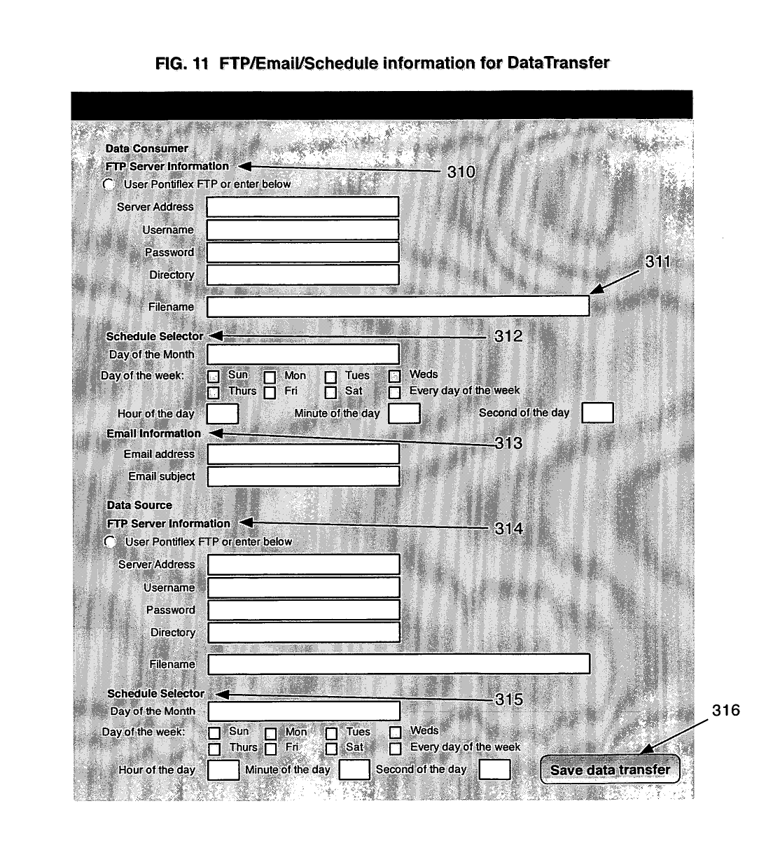

After the users clicks “Next” button 309, data transfer configurator 300 presents the screen shown in FIG. 11. If the data transfer protocol for the selected data consumer from “Select Data Consumer Configuration” list 302 is set up as FTP or SFTP, data transfer configurator 300 will show FTP Server Information form 310 (as shown on the screen shown in FIG. 11). The values for FTP Server Information form 310 will be pre-populated from FTP Server Information from the data consumer configuration. In accordance with one or more such embodiments of the present invention, the user can override this information by entering a different FTP server address, username, password and/or directory in FTP Server Information 310 as shown on the screen shown in FIG. 11. In addition, the user can also override this information by selecting to use an FTP server provided by computer system 1000. In this case, computer system 1000 will create an FTP username, password and directory in primary data store 600. If the data transfer protocol for the selected data consumer from “Select Data Consumer Configuration” list 302 is set up as FTP or SFTP or Email, data transfer configurator 300 will show Filename form 311 on the screen shown in FIG. 11. Data transfer engine 500 will use the filename entered in this field to name the files used for the data transfers sent to the data consumer.

If the data transfer protocol for the selected data consumer from “Select Data Consumer Configuration” list 302 is set up as FTP or SFTP or Email, data transfer configurator 300 will show Schedule Selector form 312 wherein the user can specify a schedule in the form of day of month, day of week, and hour/minute/second of day. Data transfer configurator 300 will use the values entered in Schedule Selector form 312 to set up a transfer schedule in data transfer scheduler 400. Data transfer scheduler 400 will send the data transfer to the data consumer using data transfer engine 500 according to the specified schedule. If the data transfer protocol for the selected data consumer from “Select Data Consumer Configuration” list 302 is set up as Email, data transfer configurator 300 will show Email Information form 313 as shown on the screen shown in FIG. 11. The values for Email Information form 313 will be pre-populated with email information from the data consumer configuration. The user can override this information by entering a different email address and email subject in Email Information form 313 as shown on the screen in FIG. 11.

If the data transfer protocol for the selected data source from “Select Data Source Configuration” list 301 is set up as FTP or SFTP, data transfer configurator 300 will show FTP Server Information form 314 (as shown on the screen shown in FIG. 11). The values for FTP Server Information form 314 will be pre-populated from FTP Server Information from the data source configuration. In accordance with one or more such embodiments of the present invention, the user can override this information by entering a different FTP server address, username, password and/or directory in FTP Server Information form 314 as shown on the screen in FIG. 11. In addition, the user can also override this information by selecting to use an FTP server provided by computer system 1000. In this case, computer system 1000 will create an FTP username, password and directory in primary data store 600. If the data transfer protocol for the selected data source from “Select Data Source Configuration” list 301 is set up as FTP or SFTP, data transfer configurator 300 will show Schedule Selector form 315 wherein the user can specify a schedule in the form of day of month, day of week, and hour/minute/second of day. Data transfer scheduler 400 will pull data from the data source using data transfer engine 500 according to the specified schedule. Next, the user clicks “Save data transfer” button 316 and data transfer configurator 300 saves the data transfer configuration in configuration data store 250.

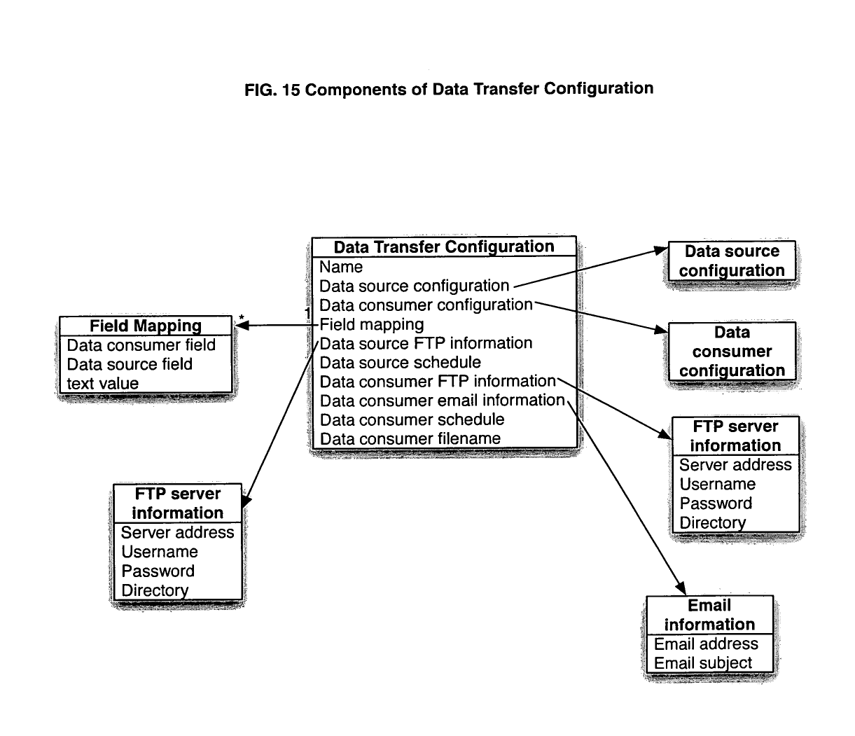

Finally, in accordance with one or more embodiments of the present invention, data transfer configurator 300 stores the configuration in machine-readable format (for example and without limitation, in xml or as normalized database tables) in configuration data store 250 (in accordance with any one of a number of methods that are well known to those of ordinary skill in the art). The data components comprising the data transfer configuration is detailed in FIG. 15.

In accordance with one or more embodiments of the present invention, data transfer scheduler 400 is a module of computer system 1000 that is used in the manner described below for data transfers that are set up to use an FTP, an SFTP or an Email data transfer protocol. According to the schedule specified during data transfer configuration, data transfer scheduler 400 will send data to a data consumer or pull data from a data source.

Data transfer scheduler 400 uses established and pre-existing implementations of job scheduling algorithms such as, for example and without limitation, Unix crontab or jcrontab.

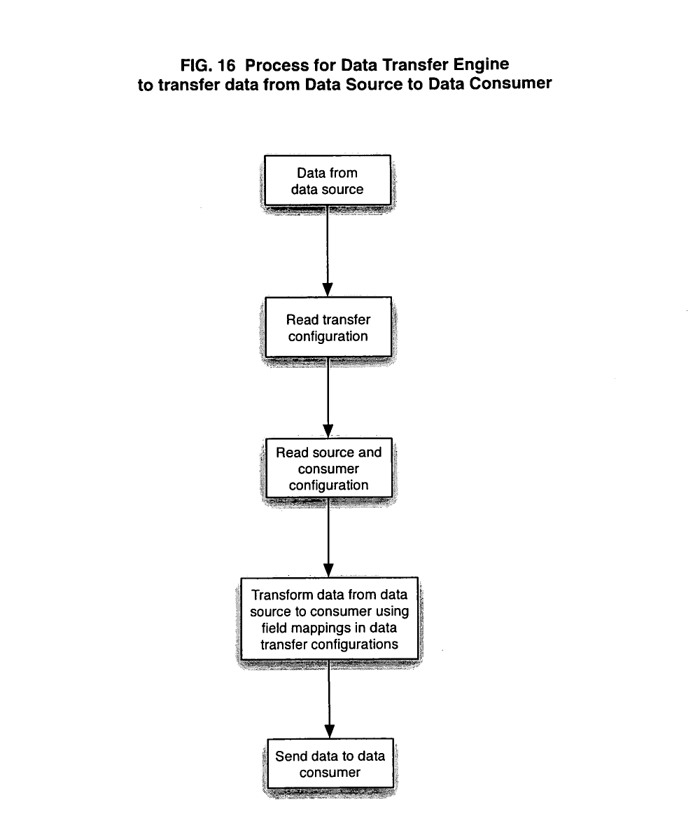

Data transfer engine 500 handles the actual transfer of data from a data source to a data consumer (in accordance with any one of a number of methods that are well known to those of ordinary skill in the art). For a data transfer, a data transfer engine retrieves a data source configuration, a data transfer configuration, and a data consumer configuration from configuration data store 250. Data transfer engine 500 receives data from the data source, transforms the received data into a form required by the data consumer as specified in the data consumer configuration and data transfer configuration, and sends the transformed data to the data consumer. In accordance with one or more embodiments of the present invention, a data transfer engine is capable of communicating in an open protocol such as, for example and without limitation, FTP, SFTP, RCP, SCP, HTTP, HTTPS, and SOAP. FIG. 16 is a flowchart summarizing the process whereby data transfer engine 500 transfers data from a data source to a data consumer.

In accordance with one or more embodiments of the present invention, primary data store 600 is a module of computer system 1000 that is used when a data source or a data consumer chooses to send data to or receive data from, respectively, computer system 1000 using FTP, SFTP or Email data transfer protocols. In accordance with one or more embodiments of the present invention, primary data store 600 comprises multiple data stores that are load-balanced (in accordance with any one of a number of methods that are well known to those of ordinary skill in the art). In accordance with one or more embodiments of the present invention, the data stores of primary data store 600 expose one or more of an FTP, an SFTP, an SCP, an HTTP, an HTTPS, an SMTP, and a Web Service interface (in accordance with any one of a number of methods that are well known to those of ordinary skill in the art). In accordance with one or more embodiments of the present invention, the interfaces will be exposed by using open source or third party proprietary software such as, for example and without limitation, proftpd (FTP), Apache web server (HTTP, HTTPS), and so forth. In addition, and in accordance with one or more embodiments of the present invention, all of the data stores of primary data store 600 share a common authentication module for example and without limitation, openldap (LDAP) that is fabricated in accordance with any one of a number of methods that are well known to those of ordinary skill in the art. Advantageously, this enables the same authentication token to be used across multiple data stores in accordance with any one of a number of methods that are well known to those of ordinary skill in the art.

Further, in accordance with one or more embodiments of the present invention, primary data store 600 can create separate, secure data areas for each data source and data consumer, and can auto-generate credentials in a common authentication module to access these data areas (in accordance with any one of a number of methods that are well known to those of ordinary skill in the art). The credentials are auto-generated during the data transfer configuration process if the user selects to use computer system 1000's FTP server for data transfer.

Data Transfer Scenarios

The following data transfer scenarios depict how data transfers from a data source and a data consumer are handled among data transfer scheduler 400, data transfer engine 500, and primary data store 600 in accordance with one or more embodiments of the present invention.

For the sake of illustration, in a first scenario, a data source sends data, one row at a time via HTTP, HTTPS, or Web Service, and in this first scenario, a data consumer has elected to receive data, as batch files, at a scheduled interval. In this case, in accordance with one or more embodiments of the present invention, the data source will send data to primary data store 600 via a HTPP/HTTPS GET or POST request to a URL hosted by primary data store 600. The data source will include a data transfer id (which was created during data transfer configuration using data transfer configurator 300) as part of the HTTP/HTTPs request to primary data store 600. Primary data store 600 forwards the data to data transfer engine 500 to be processed. Data transfer engine 500 reads the data transfer id, and loads the data transfer configuration from configuration data store 250. The data transfer configuration contains the data consumer id and data source id which are involved in the data transfer. Data transfer engine 500 then loads the data source configuration and the data consumer configuration from configuration data store 250. The data transfer configuration contains a mapping from data source fields to data consumer fields which the data transfer engine 500 will use to derive values of the data consumer fields from data source field values passed in by the data source. Data transfer engine 500 then marks these data consumer field values as new data, and stores them in primary data store 500. Further, in accordance with one or more embodiments of the present invention, at the configured scheduled time (specified in the data transfer configuration), data transfer scheduler 400 will trigger data transfer engine 500 to send the data to the data consumer. Data transfer engine 500 will read the new data from primary data store 600, create a new file, and send it to the data consumer via a data transfer method selected by the data consumer during data consumer configuration.

In a second scenario, a data source sends data, as batch files via FTP, Email or SFTP, and in this second scenario, a data consumer has elected to receive data, one row at a time via HTTP or HTTPS. Furthermore, the data source has elected to use a computer system 1000-provided data store. When the data source uploads a new data file to primary data store 600, primary data store 600 triggers data transfer engine 500 to process the new data file. Data transfer engine 500 will load the data transfer configuration from configuration data store 250 using the data transfer id, which data transfer id is part of the location information for the data area where the data source uploads the data file to primary data store 600. The data transfer configuration contains the data consumer id and data source id which are involved in the data transfer. Data transfer engine 500 then loads the data source configuration and data consumer configuration from configuration data store 250. Data transfer engine 500 then reads the data file, and for each row of the data file, data transfer engine 500 will parse the row to data source fields using delimiter or fixed-width information provided in the data source configuration and derive values of the data consumer fields from the data source field values using the mapping of data source fields to data consumer fields provided in the data transfer configuration. Data transfer engine 500 reads the data consumer HTTP/HTTPS URL from the data consumer configuration, uses this URL and the data consumer fields to construct the HTTP/HTTPS request to the data consumer, and sends the data to the data consumer.

In a third scenario, a data source sends data, one row at a time via HTTP, HTTPS, or Web Service, and in this third scenario, a data consumer has elected to receive data, one row at a time via HTTP or HTTPS. In this case, in accordance with one or more embodiments of the present invention, the data source will send data to primary data store 600 via a HTPP/HTTPS GET or POST request to a URL hosted by the primary data store 600. The data source will include a data transfer id (which was created during data transfer configuration using the data transfer configurator 300) as part of the HTTP/HTTPS request to primary data store 600. Primary data store 600 forwards the data to data transfer engine 500 to be processed. Data transfer engine 500 reads the data transfer id and loads the data transfer configuration from configuration data store 250. The data transfer configuration contains the data consumer id and data source id which are involved in the data transfer. Data transfer engine 500 then loads the data source configuration and the data consumer configuration from configuration data store 250. The data transfer configuration contains the mapping from data source fields to data consumer fields which data transfer engine 500 will use to derive the values of the data consumer fields from the data source field values passed in by the data source. Data transfer engine 500 reads the data consumer HTTP/HTTPS URL from the data consumer configuration, uses the URL and the data consumer fields to construct the HTTP/HTTPS request to the data consumer, and sends the data to the data consumer.

In accordance with one or more embodiments of the present invention, all data that is transferred through data transfer engine 500 is recorded by tracking and billing component 700. In particular, in accordance with one or more embodiments of the present invention, a data transfer engine will record the data source and data consumer for each row of data, the number of rows received from the data source in a given hour, and the number of rows that were successfully sent to the data consumer. In accordance with one or more embodiments of the present invention, tracking and billing component 700 also exposes a web interface which the data consumer, the data source, or a system manager can use to run reports on data numbers recorded by tracking and billing components 700 (in accordance with any one of a number of methods that are well known to those of ordinary skill in the art).

In accordance with one or more embodiments of the present invention, in the common case where a data source chooses to send data to computer system 1000 via an HTTP or HTTPS data transfer protocol, the data source has an option to send the data to computer system 1000 using a BrowserScriptPost code snippet that will be generated by computer system 1000, and will be available to download by the data source via a computer system 1000-provided web interface (alternatively, computer system 1000 may provide the snippet by email or a human user of computer system 1000 may cause the snippet to be down loaded). Advantageously, the BrowserScriptPost code provides a way to send data records directly to computer system 1000 in real time without the data source's having to write custom backend code. Advantageously, this allows a data source such as, for example and without limitation, a publisher of online advertising, ad networks and others, to capture user data and send it to computer system 1000 with minimal effort. The simplicity and ease of use of BrowserScriptPost code powered by computer system 1000 will allow rapid implementation and wider adoption of publisher-collected advertising methods such as co-registration and lead generation. In essence, as will be described below, set up for this functionality involves inserting a few lines of, for example and without limitation, JavaScript into, for example and without limitation, the Success or Thank You page at the end of a deal process flow.

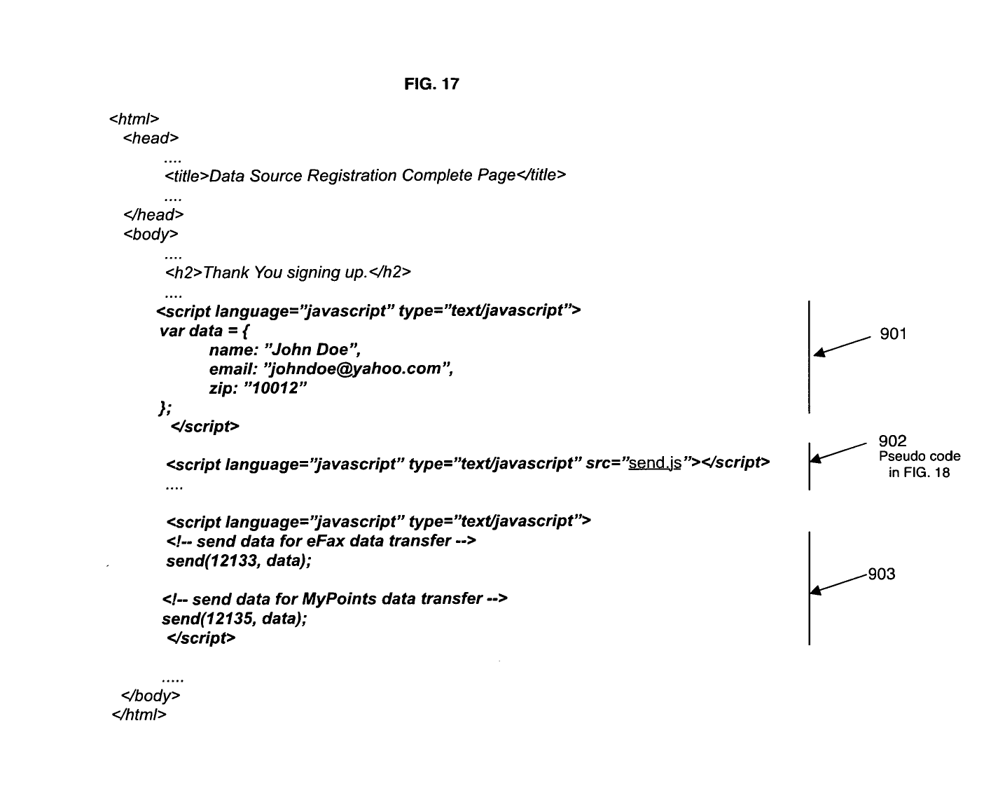

In accordance with one or more embodiments of the present invention, the BrowserScriptPost code snippet is provided to the data source in a browser based scripting language, for example, in the common case where the data source is collecting data via HTML web forms, the BrowserScriptPost code snippet will be provided as a JavaScript code snippet. The data source will insert the BrowserScriptPost code snippet into its HTML web form so that it may be used after the data it is sending to computer system 1000 has been collected by the data source, for example, after a user registration or order form step has been completed. FIG. 17 shows an HTML source code view of a sample data source-owned HTML web page that includes a BrowserScriptPost code snippet that is fabricated in accordance with one or more embodiments of the present invention. As shown in FIG. 17, the BrowserScriptPost code snippet comprises three components: (a) a first component, data object 901, is an object that contains data to be transferred to computer system 1000 that can be accessed by the browser scripting language; (b) a second component, component 902, is a function that converts data object 901 to a request for an image resource from computer system 1000; and (c) a third component, component 903, is a call to the function defined in component 902 that passes data object 901 as a parameter, thereby effectively sending data collected by the data source in data object 901 to computer system 1000 as part of the image request.

In accordance with one or more embodiments of the present invention, in the common case where the BrowserScriptPost code snippet is provided as a JavaScript code snippet, data object 901 is a JavaScript object which is a collection of properties of key name and value pairs such as, for example and without limitation, data={name:“name_value”, email:“email_value”, zip:“zip_value”}. This JavaScript object is generated for the data source by computer system 1000 by populating the key names as the names of the fields defined by the data source in data source configurator 200 in List of data fields 202 on the screen shown in FIG. 6. The values for the keys will be the data collected by the data source that it wants to send to the data consumer via computer system 1000. The values will be populated by the data source in the JavaScript object using any technology such as, for example and without limitation, JSP, ASP, ASP.NET, PHP that the data source uses to generate the data source's HTML web pages.

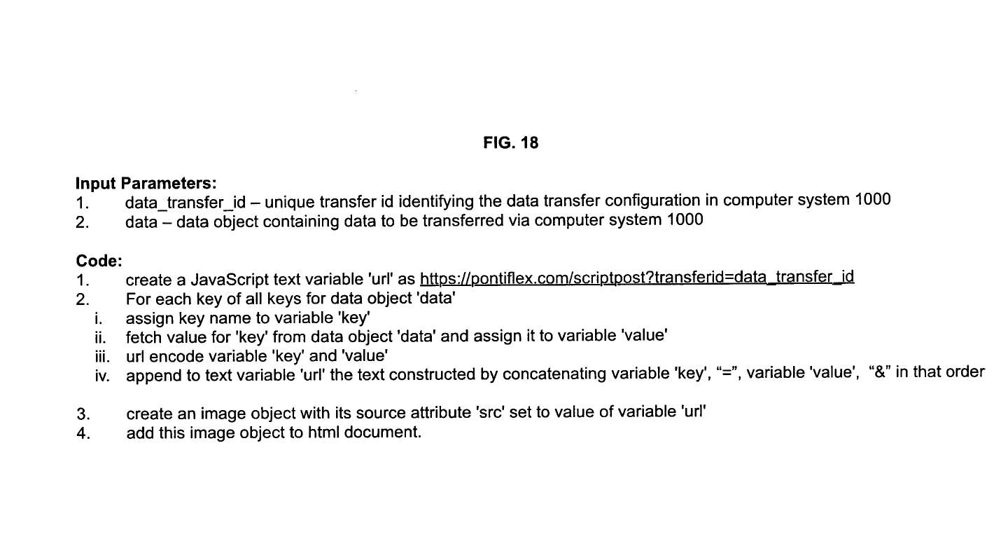

In accordance with one or more embodiments of the present invention, in the common case where the BrowserScriptPost code snippet is provided as a JavaScript code snippet, the JavaScript function of component 902 reads the JavaScript object of component 901, and constructs (using any one of a number of methods that are well known to those of ordinary skill in the art) and adds a request for an image file from computer system 1000 to the data source's HTML web page. FIG. 18 shows pseudo code describing the JavaScript function of component 902. The request for the image file resource is constructed as an HTTP GET request with the key and value pairs of the JavaScript object of component 901 added in as parameters to the HTTP GET request. In addition to these GET parameters, a data transfer id identifying the data transfer configuration is also passed as a parameter to the JavaScript function of component 902. This data transfer id is also added as a parameter to the HTTP GET request. The data collected by the data source is thus passed on to computer system 1000 for onward transfer by computer system 1000 to the data consumer specified in the data transfer configuration.

In accordance with one or more embodiments of the present invention, the data source can download the JavaScript for components 901 and 902 for each data source configuration set up using data source configurator 200 by clicking on the “Download Browser Script Enabler Code” button as shown on the screen shown in FIG. 5.

In accordance with one or more embodiments of the present invention, in the common case where the BrowserScriptPost code snippet is provided as a JavaScript code snippet, component 903 is a call to the JavaScript function defined by component 902, which function accepts, as parameters, the data transfer id and the JavaScript object created by component 901, for example, send(123345, data). In accordance with one or more such embodiments, computer system 1000 will provide an instance of the JavaScript code to the data source for component 903 for each data transfer defined in data transfer configurator 300 that has been configured to accept data from the data source. The data source can download an instance of component 903 for each data transfer configuration by clicking on the “Download Browser Script Transfer Code” button on screen shown in FIG. 8. The unique data transfer id identifying the data transfer is generated by the computer system 1000 on creation of a new data transfer configuration, and will be populated by computer system 1000 in each instance of the Java Script code snippet for component 903. For each instance where the data source wants to send collected data in component 901 to computer system 1000, the data source will place calls to the JavaScript function on the web page after placing the JavaScript code for component 901 and 902 using any technologies such as, for example and without limitation, JSP, ASP, ASP.NET, PHP that the data source uses to generate data source's HTML web pages.

Based on the examples given above for component 901 and 903, the HTTP GET request for an image resource from computer system 1000 will be constructed by component 902 as: https://pontiflex.com/scriptpost?transferid=123345 &name=name_value&email=email_value&zip=zip_value.

The image resource request that will be added to the data source's HTML web page will be added as an HTML image tag that will look like <img src=“https://pontiflex.com/scriptpost?transferid=123345 &name=name_value&email=email_value&zip=zip_value”/>.

In accordance with one or more embodiments of the present invention, archiver 800 runs at a system-defined archival time interval, and moves data; older than the archival time interval, from primary data store 600 to an archival data warehouse of archiver 800 (in accordance with any one of a number of methods that are well known to those of ordinary skill in the art).

The embodiments of the present invention described above are exemplary. Many changes and modifications may be made to the disclosure recited above while remaining within the scope of the invention. For example, although the specification has described embodiments related to Internet advertising, those of ordinary skill in the art should understand that further embodiments exist that are useful for mobile telephone commerce and advertising, cable and Internet television, and other markets where heterogeneous entities need to connect in order to transfer data in real-time, such as, for example and without limitation, financial services and markets, health care and others. The scope of the invention should therefore be determined not with reference to the above description, but instead should be determined with reference to the appended claims along with their full scope of equivalents.

What is claimed is:

1. A data bridge between publishers and advertisers for sending data from a publisher to an advertiser, which data bridge comprises:
a computer system, which computer system includes:
a data consumer configurator;
a data source configurator;
a configuration data store;
a data transfer configurator;
a data transfer scheduler;
a data transfer engine;
a primary data store;
a tracking and billing component; and
an archiver.

2. The data bridge of claim 1 wherein:
(a) the data consumer configurator provides a web-enabled interface to set up advertiser configurations that specify (i) data transfer protocols used to transfer data from the computer system to advertisers, and (ii) data transfer fields that make up each record of data to be sent to the advertisers;
(b) the data source configurator provides a web-enabled interface to set up publisher configurations that specify (i) data transfer protocols used to transfer data from publishers to the computer system, and (ii) data fields that make up each record of data received from the publishers; and
(c) the data transfer configurator provides a web-enabled interface to set up data transfer configurations that specify (i) whether the computer system will pull data from publishers or the publishers will push data to the computer system, (ii) where the publishers will push data to the computer system, the computer system will create data storage areas, and, if required by data transfer protocols specified in the publisher configurations, will generate credentials to access the data storage areas, (iii) where the computer system will pull data from the publishers, data store information and credentials required by the computer system to access a data store created by the publishers, (iv) whether the computer system will push data to advertisers or the advertisers will pull the data from computer system, (v) where the advertisers will pull data from the computer system, the computer system will create data storage areas for the data transfer, and, if required by data transfer protocols specified in advertiser configurations, generate credentials to access the data storage areas, and (vi) where the computer system will push data to the advertisers, the data store information and credentials required by the computer system to access the data storage area created by the advertisers.

3. The data bridge of claim 2 wherein the data transfer configurator further automatically matches a list data fields to be sent to the advertisers to a list of data fields received from the publishers and provides a web-based form to have advertisers or publishers verify or modify matches between the data fields.

4. The data bridge of claim 3 wherein the configuration data store comprises:
configuration data for use in data transfer from publishers to the computer system wherein the configuration data includes: (a) a list of data fields to send, a relative ordering of the data fields, and a format for the data fields; (b) a data transfer protocol for sending data to computer system; and (c) server information defining where publishers will send data, along with security credentials to access the server.

5. The data bridge of claim 4 wherein the configuration data is stored in xml or as normalized database tables.

6. The data bridge of claim 4 wherein the configuration data store comprises:
configuration data for use in data transfer from the computer system to advertisers wherein the configuration data includes: (a) a list of data fields to send, a relative ordering of the data fields, and a format for the data fields; (b) a data transfer protocol for receiving data from the computer system; and (c) server information where defining where the computer system will send data, along with security credentials to access the server.

7. The data bridge of claim 6 wherein the configuration data is stored in xml or as normalized database tables.

8. The data bridge of claim 3 wherein the data transfer configurator provides matching using a module that automatically guesses mapping of the advertiser list of fields to the publisher list of fields using string matching algorithms.

9. The data bridge of claim 8 wherein the data transfer configurator includes modules for providing a series of computer system hosted web forms for use by a user to change the mapping of the advertiser list of fields to publisher list of fields as guessed by the data transfer configurator.

10. The data bridge of claim 9 wherein the data transfer configurator includes modules for providing a series of computer system hosted web forms for use by a user to remove the mapping of an advertiser field to publisher field as guessed by the data transfer configurator and instead map the advertiser field to a fixed text value.

11. The data bridge of claim 10 wherein the data transfer engine reads data transfer configuration information and causes data to be transferred data from the publisher to the advertiser.

12. The data bridge of claim 2 wherein the data includes data in tabular form having rows and columns, and the wherein the data from an advertising campaign includes individual leads in rows and lead properties as data fields in columns in the form one or more of first name, lastname, and email address.

13. The data bridge of claim 1 wherein the data source configurator and the data transfer configurator provide code snippets to be downloaded by the data source, which code snippets are used to transmit data from the data source to the computer system.

14. The data bridge of claim 13 wherein the code snippets are in a browser based scripting language.

15. The data bridge of claim 14 wherein the code snippets are JavaScript code snippets.

16. The data bridge of claim 15 wherein the JavaScript code snippets comprise three components wherein a first component is an object that contains data to be transferred to the computer system; a second component is a function that converts the data object to a request for an image resource from the computer system; and a third component is a call to the function defined in the second component that passes the data object as a parameter, thereby effectively sending data collected by the publisher in the data object to the computer system as part of the image request.

17. The data bridge of claim 2 wherein the data transfer configurator receives publisher data transfer schedules and/or advertiser data transfer schedules, and, according to schedules specified during data transfer configuration, the data transfer scheduler cause data to be sent to an advertiser or to be pulled data a publisher.

18. A method for sending data from publishers to advertisers using a computer system, which computer system includes: (a) an advertiser configurator; (b) a publisher configurator; (c) a configuration data store; (d) a data transfer configurator; (e) a data transfer scheduler; (f) a data transfer engine; (g) a primary data store; (h) a tracking and billing component; and (i) an archiver comprises:
setting up advertiser configurations that specify (i) data transfer protocols used to transfer data from the computer system to advertisers, and (ii) data transfer fields that make up each record of data to be sent to the advertisers;
setting up publisher configurations that specify (i) data transfer protocols used to transfer data from publishers to the computer system, and (ii) data fields that make up each record of data received from the publishers;
setting up data transfer configurations that specify (i) whether the computer system will pull data from publishers or the publishers will push data to the computer system, (ii) where the publishers will push data to the computer system, the computer system will create data storage areas, and, if required by data transfer protocols specified in the data source configurations, will generate credentials to access the data storage areas, (iii) where the computer system will pull data from the publishers, data store information and credentials required by the computer system to access a data store created by the publishers, (iv) whether the computer system will push data to advertisers or the advertisers will pull the data from computer system, (v) where the advertisers will pull data from the computer system, the computer system will create data storage areas for the data transfer, and, if required by a data transfer protocol, generate credentials to access the data storage areas, and (vi) where the computer system will push data to the advertisers, the data store information and credentials required by the computer system to access the data storage area created by the advertisers; and
automatically matching a list data fields to be sent to the advertisers to a list of data fields received from the publishers and providing a web-based form to have advertisers or publishers verify or modify matches between the data fields.

19. The method of claim 18 wherein automatically matching comprises automatically guessing mapping of the advertiser list of fields to the publisher list of fields using string matching algorithms.

20. The method of claim 19 further comprising:
reading data transfer configuration information and causing data to be transferred data from the publisher to the advertiser.
